(19) United States
(12) Patent Application Publication
(10) Pub. No.: US 2016/0019665 A1
(43) Pub. Date: Jan. 21, 2016

(54) METHODS AND SYSTEMS FOR AUTOMATED DRAFTING OF COMPLAINTS FOR INITIATION OF CIVIL LEGAL ACTION

(71) Applicant: Scribo Legal Technologies, LLC, Decatur, GA (US)

(72) Inventors: Kent William Collier, Decatur, GA (US); Paul Matthew Brandon, Atlanta, GA (US)

(73) Assignee: Scribo Legal Technologies, LLC, Decatur, GA (US)

(21) Appl. No.: 14/799,058

(22) Filed: Jul. 14, 2015

Related U.S. Application Data
(60) Provisional application No. 62/024,618, filed on Jul. 15, 2014.

(51) Int. Cl. G06Q 50/18; G06F 3/0482; G06Q 20/14; G06F 17/24; G06F 17/27; G06F 17/28; G06F 17/30; G06F 3/0484

(52) U.S. Cl. CPC G06Q 50/18; G06F 17/30011; G06F 17/30528; G06F 17/30554; G06F 3/0482; G06F 3/04842; G06F 17/243; G06F 17/2705; G06F 17/28; G06F 17/277; G06Q 20/14

(57) ABSTRACT

Embodiments disclosed herein are directed to systems, methods, and apparatuses for enabling a user to quickly and efficiently generate a formal complaint document for initiating a lawsuit in a court. For example, an automated online interview process may prompt the user to make selections and/or input various pieces of information associated with the complaint. This information provided by the user may be utilized to generate the complaint. A processor of a computing system may process the provided information to identify relevant information and generate a formal complaint document by reformatting the relevant information so that the formal complaint document is tailored based on requirements of a particular court in which the complaint is to be filed. Once generated, the formal complaint document may be modified and/or downloaded by the user, transmitted to a legal professional for modification and/or submission, and/or submitted electronically to a desired court.

### CROSS REFERENCE TO RELATED APPLICATIONS

This application claims the benefit of U.S. Provisional Patent Application No. 62/024,618, filed on Jul. 15, 2014, the entire contents of which are hereby incorporated by reference.

### TECHNICAL FIELD

This disclosure generally relates to systems and methods for lawsuit filings and, more particularly, to a method and system for automated drafting of complaints to initiate civil action in court.

### BACKGROUND

In the United States, a complaint may be filed to initiate a legal action or lawsuit in court. Complaints are often prepared from scratch, or with substantial re-work of standard word processing or legal research, by attorneys or other legal professionals with complaint filing expertise and accompanying high billing rates. As such, preparation of a complaint may be time-consuming and/or prohibitively expensive for individuals or corporations. Currently, entities with limited financial resources may encounter difficulty in taking legal action due to an inability to draft legal complaints, as well as a lack of procedural knowledge.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 depicts an example user interface that enables a user to login or register, according to one or more example embodiments of the disclosure.

FIG. 2 depicts an example user interface that enables a user to input information associated with a complaint, according to one or more example embodiments of the disclosure.

FIG. 3 depicts an example user interface that enables a user to view, modify, and submit a generated complaint, according to one or more example embodiments of the disclosure.

FIG. 4 depicts an example process flow for drafting a complaint, according to one or more example embodiments of the disclosure.

FIG. 5 depicts an example of a computational environment, according to one or more example embodiments of the disclosure.

FIG. 6 depicts example computer system architecture, according to one or more example embodiments of the disclosure.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims. The word “example” is used herein to mean “serving as an example, instance, or illustration.” Any embodiment described herein as “example” is not necessarily to be construed as preferred or advantageous over other embodiments.

Legal complaints have both objective and subjective components. Objective components include document formatting, which may be dictated by court rules, general page layout, captions and headings, paragraph numbering, elements of the statement of the parties, elements of the statement as to the court's jurisdiction, organization of paragraphs and various document sections, legal elements of different causes of action, document attachments needed for a particular cause of action, form of prayer for relief, signature block, and verification form, and various accompanying documents required by court rules or custom, such as a summons, civil cover sheet, filing instructions, or notices. Subjective components of a complaint may include the parties, facts applicable to the dispute and various causes of action, and the wording and organization peculiar to any particular attorney or claimant. Embodiments of the disclosure may facilitate conversion of subjective components of a legal complaint to objective criteria using a series of claimant questions, prompts, selections, inputs, choices, and the like.

Embodiments disclosed herein are directed to systems, methods, and apparatuses for enabling a user to quickly and efficiently generate a formal complaint document that complies with local court procedural rules for filing and/or initiation of a lawsuit in a court. For example, an automated online interview process may prompt the user to make selections and/or input various pieces of information associated with the complaint. Information selected and/or inputted by the user may include personal information, courts, causes of action, laws, factual allegations such details of an event or legal relationship, and/or the like. Further, the user may be enabled to attach one or more documents relevant to the complaint.

Embodiments of the disclosure may relate to drafting of a legal document known as a complaint used to initiate a legal action or lawsuit in a court in the Federal or state courts of the United States. Example methods of the disclosure may include soliciting information from a user and generating a complaint with various causes of action selected by, or recommended to, the user, applying law selected by, or recommended to, the user, and rephrasing or processing information supplied by the user resulting from prompts and user inputs through an automated online user interview. The resulting legal document may be tailored to the requirements of the court of the user's choice and may be readily filed in the court.

Accordingly, this information provided by the user may be utilized to generate the complaint. For example, computer-executable instructions stored on a memory of a computing device may be executed by a processor of the computing system to process the provided information and generate a formal complaint document that is tailored based at least in part on requirements of a selected court. The processor of the computing system may also be configured to identify various pieces of information (e.g., additional causes of action, applicable laws, courts with jurisdiction, and/or the like) for inclusion in the formal complaint document from information provided by the user. Once generated, the formal complaint document may be modified and/or downloaded by the user, transmitted to a second user (e.g., an attorney) for modification and/or submission, and/or submitted electronically to a desired court. Additional court documents, such as summons, filing instructions (e.g., a court-specific filing instruction sheet and fee schedule, civil cover sheet, etc.), or other court-required notices or documents may also be generated and delivered to the user. In some embodiments, the formal complaint document may be presented to the user for printing and manually submitting to a court upon payment of a fee. In certain embodiments, the user may receive specific instructions on manual filing such as location of a courthouse or filing location, applicable fees and methods or requirements for remitting payment, important deadlines such as applicable limitations periods, service requirements and methods, and necessary documentation for filing. In this manner, embodiments disclosed herein may enable a user to generate and submit a formal complaint document for a specific court with ease and affordability.

In certain embodiments, users that are identified and/or certified as attorneys may be authorized to edit some or all portions of the generated complaint. For example, an attorney may be authorized to subjectively edit portions of the generated complaint, while users that are not attorneys may be restricted from editing the complaint.

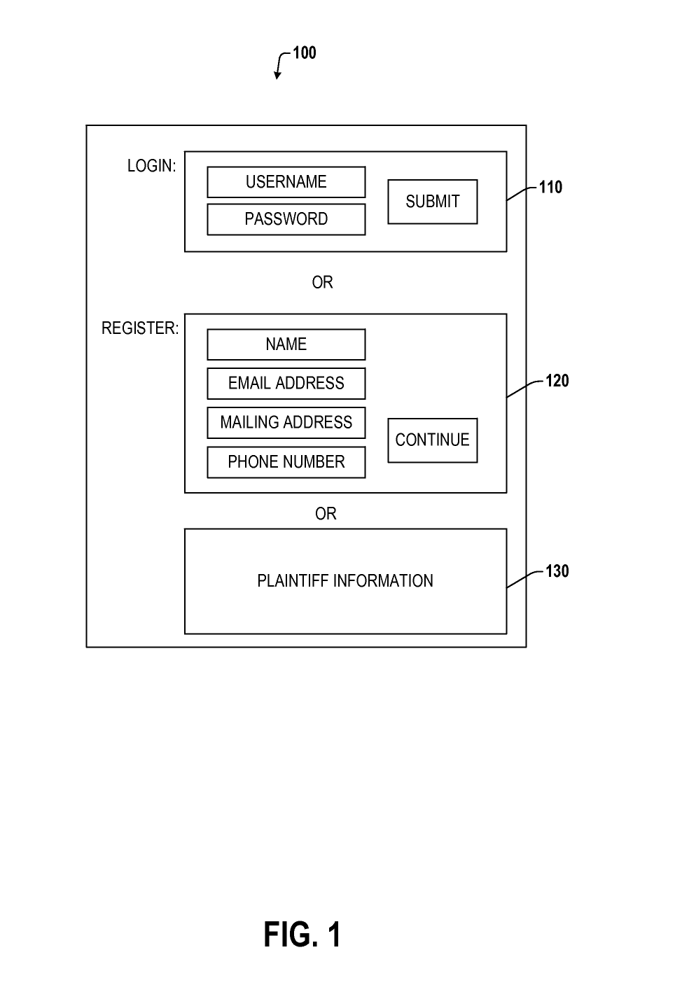

Referring now to the Figures, FIG. 1 illustrates an example user interface 100 for enabling a user to login 110 or register 120 with an online complaint drafting system (“the system”) (e.g., an online portal, software application, and/or the like). For example, to login 110 to the system, the user may provide (e.g., input) authentication credentials such as a username, a password, biometric information (e.g., a fingerprint scan, a retina scan, and/or the like), and/or the like. Provided authentication credentials may be received by the system and validated based on determining a match between the provided authentication credentials and authentication credentials known to be associated with the user and stored in a database.

Alternatively, if the user has not already registered with the system, then the user may register 120 with the system. For example, to register 120 with the system, the user may provide (e.g., input) various pieces of personal information (e.g., a user type (e.g., an individual, a corporation, a legal professional, and/or the like), a name, a corporate entity name, an email address, a physical mailing address, a phone number, a facsimile number, state and/or federal bar information, corporate representative and agent information if applicable, and/or the like), payment information (e.g., an account number, a routing number, a card number, an expiration date, a security code, a personal identification number (PIN), and/or the like), location information (e.g., a zip code, an Internet Protocol (IP) address, global positioning system (GPS) coordinates, and/or the like), corporation information (e.g., state of incorporation or organization, citizenship of members or partners (e.g., users), representative information, and/or the like), and/or any other information associated with the user necessary for identification of the user, settlement of fees, and information applicable to a user that is also a plaintiff in a complaint.

The user selects himself or herself as a plaintiff or inputs additional plaintiffs and necessary information for pleading and jurisdictional requirements at user interface component 130. Where corporate entities are to be a plaintiff for a complaint, the user may be required to list an attorney to represent the corporate entity for filing the complaint based on pre-determined legal requirements associated with the court selected for filing.

In some embodiments, the system may be integrated (e.g., in communication) with one or more other systems associated with courts, law firms, bar associations, and/or the like. As such, the system may retrieve and/or receive information associated with courts, law firms, bar associations, legal professionals, and/or the like. Further, the interface 100 may include various selection menus (e.g., drop-down menus, and/or the like) that include prefilled information that may be selected by the user (other embodiments may be configured to receive information inputted by the user). For example, the interface 100 may include a selection menu of legal professionals (e.g., a roster) who are authorized to file legal documents in a particular court. The user may then select one or more legal professionals as authorized representatives of the user.

The system may receive provided information and generate, using the provided information, a user profile for the user. The system may store the provided information and/or user profile in a database. In some embodiments, the system may also transmit the provided information and/or user profile to one or more other systems associated with a court, a law firm and/or legal professional, and/or the like for registration of the user with a court and/or legal practice.

In some embodiments, the registration process may also include establishing a subscription for one or more complaint drafts. For example, the user may wish to subscribe to the system for a predetermined number of complaint drafting operations. In some embodiments, the user may provide payment information during the registration process to establish a subscription to complaint drafting services of the system. In some embodiments, the user may establish a subscription for the system to generate one complaint draft, a plurality of complaint drafts, and/or an unlimited number of complaint drafts for a predetermined period of time. Subscription pricing may be based on information provided by the user such as a user type, location information, number of causes of action in a complaint, and/or the like.

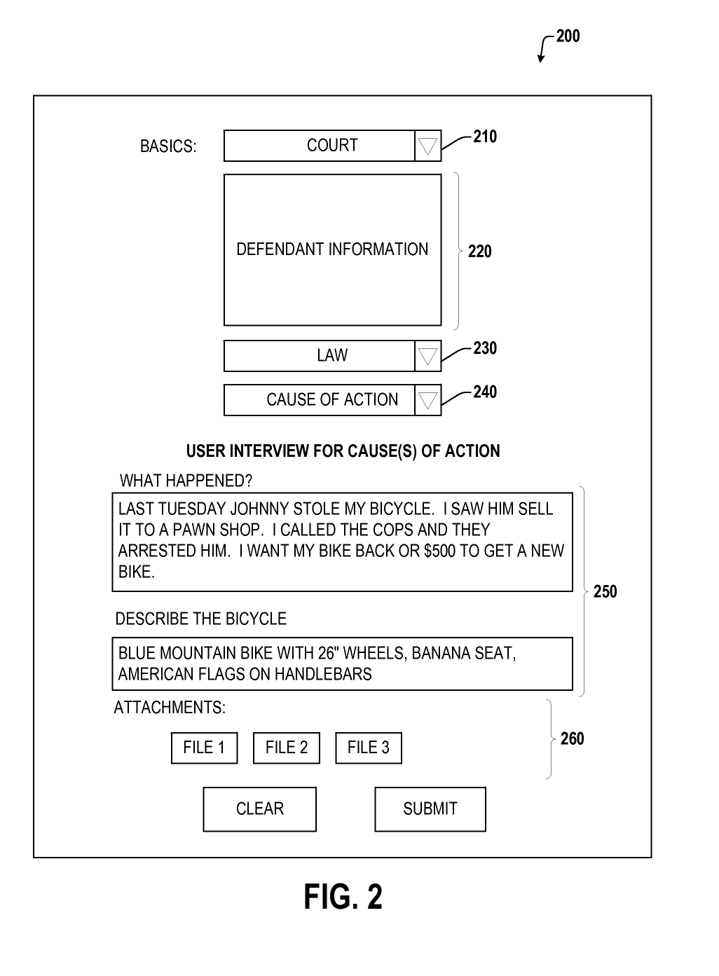

FIG. 2 illustrates an example user interface 200 for enabling the user to input and/or select information associated with a complaint. For example, the user may be enabled to select one or more desired courts 210 for filing the complaint. In some embodiments, various levels of courts 210 at state and/or federal levels (e.g., districts) may be presented to the user for selection using one or more drop-down menus. The user may also be enabled to input information associated with a court 210 such as a location, a judge, jury information, and/or the like.

In other embodiments, the user may not select a court 210. Instead, the system may determine (e.g., recommend, identify, and/or the like) one or more courts where the complaint may be filed with proper jurisdiction based on other information provided by the user (e.g., 220-260). As such, the user may skip the court selection step 210 and may provide other information prior to the system determining one or more courts 210 in which the complaint may be filed. For example, the system may determine one or more courts 210 in which the complaint may be filed based on one or more selected causes of action, parties involved in the complaint (e.g., plaintiff information and/or defendant information), an amount of money in controversy, a location of events and/or occurrences related to the selected causes of action, and/or the like. The user may then select one or more of the courts 210 determined by the system to have jurisdiction for filing of the complaint.

Based on receiving a selection of the court(s) 210 by the user, the system may prompt the user for various pieces of information. For example, selection of a first court may require a first set of information to be included in a complaint for filing in the first court, while selection of a second court may require a second set of information to be included in a complaint for filing in the second court. As such, the interface 200 may determine which prompts for information and/or required documents are presented to the user based on the selection of the court(s) 210. For example, each court 210 may require different pieces of information, different formatting (e.g., fonts, margins, headings, titles, signature requirements, and/or the like), filing procedures, documents such as cover sheets and/or summons, and/or the like. Selection of the court(s) 210 may also cause the system to determine one or more documents and/or procedures required for filing the complaint in the selected court(s) 210.

At block 220, the user may be enabled to provide information associated with the defendant 220. Information associated with the defendant 220 may include an individual name, a corporate entity name, an email address, a physical mailing address, a phone number, a fax number, representative information, attorney information, a state of incorporation or organization, citizenship information of members and/or partners, location information, a name of any representatives or agents of a corporation and/or individual, and/or the like. In some embodiments, the user may provide (e.g., input) this information 220 using the interface 200. In other embodiments, the user may select this information 220 from one or more menus using the interface 200, where the interface 200 is populated with information 220 retrieved by the system from one or more other systems (e.g., systems associated with corporate entities, administrative bodies such as bar associations, court administrations, and/or the like). In some embodiments, information associated with the defendant 220 may include information provided by the user during the registration process and/or information included in one or more user profiles and/or entity profiles. The information 220 may also be prefilled at least in part by the system. Multiple defendants may be input by repeating this process.

The system, in response to receiving defendant information 220, may perform a jurisdiction conflict check to determine whether the complaint can be filed in the selected court(s) 210. In some embodiments, the system may perform jurisdiction conflict checks at any time during operation (e.g., before, concurrently, and/or after performing any other operation). In some embodiments, performing a jurisdiction conflict check includes comparing received information (e.g., defendant information 220 and/or other information provided and/or selected by the user) to one or more jurisdictional requirements associated with the selected court(s) 210.

The user may then select one or more laws 230 applicable to the complaint. For example, the user may select one or more laws 230 from a drop-down menu populated (e.g., determined) by the system based on selection of the court(s) 210 and/or defendant information 220. The one or more laws 230 may be specific to a city, state, district, Federal, or other jurisdictional entity, for example.

The user may then select and/or input one or more causes of action 240 applicable to the complaint. For example, the user may select one or more causes of action 240 from a drop-down menu populated by the system based on selection of the court(s) 210, defendant information 220, and/or applicable law(s) 230. In some embodiments, causes of action may include state law based causes of action including, but not limited to, assault, battery, recovery of a contractual contingency fee by an attorney, a breach of contract, an account stated, a quantum meruit and/or an unjust enrichment, a professional negligence for an architect, engineer, attorney, broker, dealer, accountant, doctor, and/or the like, a breach of a promissory note, a foreclosure on a mortgage or a deed of trust, a breach of contract for liquidated damages, a covenant not to compete, a non-disclosure or confidentiality agreement, and/or the like, a wrongful termination of an employee, a lien foreclosure, legal malpractice, negligence, a breach of fiduciary duty relating to general matters, self-dealing, a misuse of entrusted funds, assets or property, a misappropriation of entrusted funds, assets or property, mismanagement, and/or the like, negligent entrustment, product liability for a failure to warn, a manufacturing defect, a design defect, and/or the like, fraud, misrepresentation, a deceptive trade practice, a consumer protection statute, a wrongful dishonoring of a check, a wrongful honoring of a forged check, a failure to comply with a stop payment order, a wrongful freezing of or denial of access to funds on deposit, a wrongful deduction or setoff against funds on deposit, a wrongful denial of payment under letter of credit, a collection of a loan deficiency, a wrongful repossession of collateral security, a conversion, civil theft, wrongful denial of insurance coverage for a pre-existing condition, a breach of the covenant of quiet enjoyment, a breach of an implied warranty of habitability, a recovery of a security deposit, a breach of a lease, a failure to maintain or repair leased premises, unlawful entry into leased premises, a breach of contract for a real property purchase agreement, a forfeiture of earnest money, a recovery of earnest money, a negligent provision of bailment services, a failure to honor confirmed hotel or motel reservations, a breach of contract for an exclusive listing of real estate, a specific performance for sale of real property, a state false claim act, a misappropriation of corporate property, an usurping of corporate business opportunity, a failure to procure insurance, an intentional interference with a contractual relationship, a negligent interference with a contractual relationship, a tortious interference with a prospective business advantage, business slander, damage to goodwill, a breach of an implied warranty of merchantability, a breach of an implied warranty of fitness for a particular purpose, a fraudulent transfer or concealment of property or assets, a trademark infringement, misappropriation of proprietary information, misappropriation of trade secrets, selective enforcement of covenants, a violation of building code, identity theft, invasion of privacy, a breach of an express warranty, slander of title, libel, slander, a vicarious liability of an employer, an unlawful retaliatory discharge, negligent hiring, negligent supervision, negligent training, false imprisonment, bad faith, abuse of process, malicious prosecution, medical malpractice, negligent diagnosis of an illness, negligent treatment or medical care, leaving foreign object in body, failure to maintain safe and clean conditions, breach of express bailment, breach of implied bailment, negligent service of alcohol, declaratory judgment to establish coverage under insurance policy, bad faith refusal to settle claim by insurer, breach of insurance contract, breach of performance bond, breach of payment bond, breach of guaranty, civil conspiracy, interference with easement or right-of-way, nuisance, trespassing, establish ownership by prescription, violation of view, air, or light easement, or violation of odometer disclosure requirements under federal motor vehicle information and cost savings act, or a cause of action based on United States, or Federal, statute or regulation, including, but not limited to, 15 U.S.C. §§1988, 1989, unlawful discrimination under the federal equal credit opportunity act, 15 U.S.C. §1691, et seq., unlawful discrimination by employer, false claims act, 31 U.S.C. §3729 et seq., arming vessels against friendly nations, 18 U.S.C. §962, violation of Indian protection, 25 U.S.C. §201, removal of undersea treasure to foreign nations, 46a U.S.C. §723, copyright infringement, 17 U.S.C. §§101, et seq., misrepresentation or fraud in commercial advertising or business promotion, 15 U.S.C. §1125, violation of the federal fair credit reporting act, 15 U.S.C. §1681, sexual harassment, 42 U.S.C. §2000e, et seq., violation of equal pay act, 29 U.S.C. §206(d), violation of rights under employee retirement income security act, 29 U.S.C. §1001, et seq., 42 U.S.C. §1983, federal tort claim act, 28 U.S.C. §1346, 2671-2680, and/or the like. The system may include some or all causes of action available in all United States Federal courts and the courts of the various states and territories of the United States.

The system may further be enabled to initiate a user interview process including various questions, prompts, choices, suggestions, and/or options that allows the system to receive from the user and/or develop facts necessary to allege elements of the causes of action 240 and/or perform jurisdictional conflict checks. In some embodiments, a unique user interview process may be initiated by the system for each selected applicable law 230 and/or cause of action 240. For example, the system may prompt the user with a series of questions in a user interview 250 so that the user may provide more detailed information associated with the selected cause(s) of action 240. This may include presenting one or more interfaces to the user that enable the user to input, select, and/or otherwise provide information associated with selected causes of action 240. In some embodiments, the series of questions (e.g., prompts) 250 may be determined and/or presented to the user by the system based on selection of the court(s) 210, defendant information 220, applicable law(s) 230, and/or the cause(s) of action 240.

Additionally, the system may prompt the user to upload one or more files of required documents 260 for generating and/or filing the complaint. For example, the system may enable the user to upload one or more documents and/or other files relevant to the complaint. In some embodiments, the required documents 260 for filing the complaint may be determined by the system based on selection of the court(s) 210, defendant information 220, applicable law(s) 230, the cause(s) of action 240, and/or information provided by the user in response to the one or more questions 250. The system may store received selections and/or information in a database for later recall at various times during operation.

In some embodiments, the system may suggest one or more causes of action 240 that may also be relevant based on information provided by the user when responding to the series of questions 250, provided documents 260, and/or other information. The system may also suggest one or more modifications to provided information and/or causes of action 240 based on provided information.

In some embodiments, the system may process (e.g., scan, analyze, parse, search, and/or the like) provided information (e.g., defendant information 220, information associated with a response to one or more questions 250 pertaining to the causes of action 240, any uploaded document 260, and/or the like. For example, the system may analyze content of an uploaded document 260 using natural language processing techniques to identify one or more keywords, common themes, allegations, patterns, and/or pieces of information relevant to describing facts associated with one or more causes of action 240. In this manner, the system may be enabled to extract information relevant to factual allegations of the cause(s) of action 240 without further user interaction. For example, the system may determine that the user has inputted the terms “car accident,” “injury,” and/or other similar words and therefore may recommend causes of action related to these terms not selected by the user for inclusion in the complaint. In some embodiments, identifying keywords may include comparing words included in text provided by the user via interface 200 and words stored in a database with a known association with one or more causes of action, courts, applicable laws, and/or the like. In certain embodiments, the system may organize, format, rewrite, and/or properly sequence some or all of the user inputted text, based at least in part on the user selections. For example, the system may revise inputted and/or default language into a set of factual pleadings applicable to an entirety of the complaint or a specific cause or causes of action, as applicable, by extracting information from the inputs and choices by comparing the inputted text to a set of terms in a database. Processes such as natural language processing and/or regeneration of information into readable human language using clauses, words, and forms from a selection created by variable criteria may be output by the system. Certain embodiments of the disclosure may recognize, via processing of the inputted text, common themes, allegations, and/or patterns by natural language processing and understanding, and the system may suggest other potentially applicable causes of action for user review and selection. Legal requirements related to pleading standards, including heightened pleading or pleading with particularity may change the level of user interview and the type or amount of information collected from the user for various causes of action or based on the law applicable to a cause of action.

Upon receipt, determination, and/or extraction of information required for generating the complaint (e.g., information associated with elements 210-260), the system may perform one or more conflict checks to determine whether the complaint can be filed in the selected court(s) 210. In some embodiments, the system may determine a conflict exists, such as identifying that a selected court 210 lacks jurisdiction regarding subject matter associated with the complaint and/or one or more causes of action 240. As another example, the system may determine that information provided by the user relating to one or more causes of action 240 is inconsistent. The system may notify the user that a conflict has been identified and may further enable the user to modify information (e.g., selections of court(s) 210, defendant information 220, applicable law(s) 230, cause(s) of action 240, responses to questions 250, information associated with one or more documents 260, and/or the like) to correct the identified conflict. This conflict resolution process may be repeated multiple times and/or at various times throughout operation of the system.

Next, the system may generate one or more formal complaint documents using the provided and/or retrieved information. In some embodiments, the system may generate a formal complaint document by populating a form and/or template specific to the selected court(s) 210, applicable law(s) 230, causes of action 240, and/or other information. In other embodiments, the system may instead generate a formal complaint document and/or portions of a formal complaint document from scratch (e.g., using no template) based on one or more rules specific to the selected court(s) 210, applicable law(s) 230, causes of action 240, and/or other information. For example, the system may draft a formal complaint document using specific paragraph numbering and/or formatting, word processing formatting, and/or other formatting techniques specific to the selected court 210. Further, the generated formal complaint document may be generated in an organizational manner (e.g., ordering of paragraphs, and/or the like) based on the cause(s) of action 240 and/or other provided information. The system may generate the formal complaint document by translating (e.g., re-writing, organizing, formatting, and/or the like) the provided information into a set of factual pleadings applicable to the complaint and/or one or more causes of action. In some embodiments, the system may combine various pieces of information to form human-readable words, clauses, sentences, and/or the like. In some embodiments, multiple formal complaint documents may be required by the selected court(s) 210. Accordingly, the system may generate multiple documents such as a complaint document, a cover sheet, a corporate disclosure sheet, a summons, various exhibits and/or attachments, fee transmittal sheets, notices, and/or any other documents. In some embodiments, the one or more formal complaint documents may be generated in a particular format such as a portable document format (PDF).

In some embodiments, prior to presentation of the generated formal complaint documents to the user, the system may prompt the user for payment information. For example, the system may calculate an estimated fee associated with generating the formal complaint document, filing the formal complaint document in the selected court(s) 210, and/or the like. The user may provide payment information to the system or, alternatively, the system may retrieve payment information and/or subscription information included in a user profile of the user. The system may further facilitate a payment transaction between an account of a user and an account associated with the system and/or one or more courts 210.

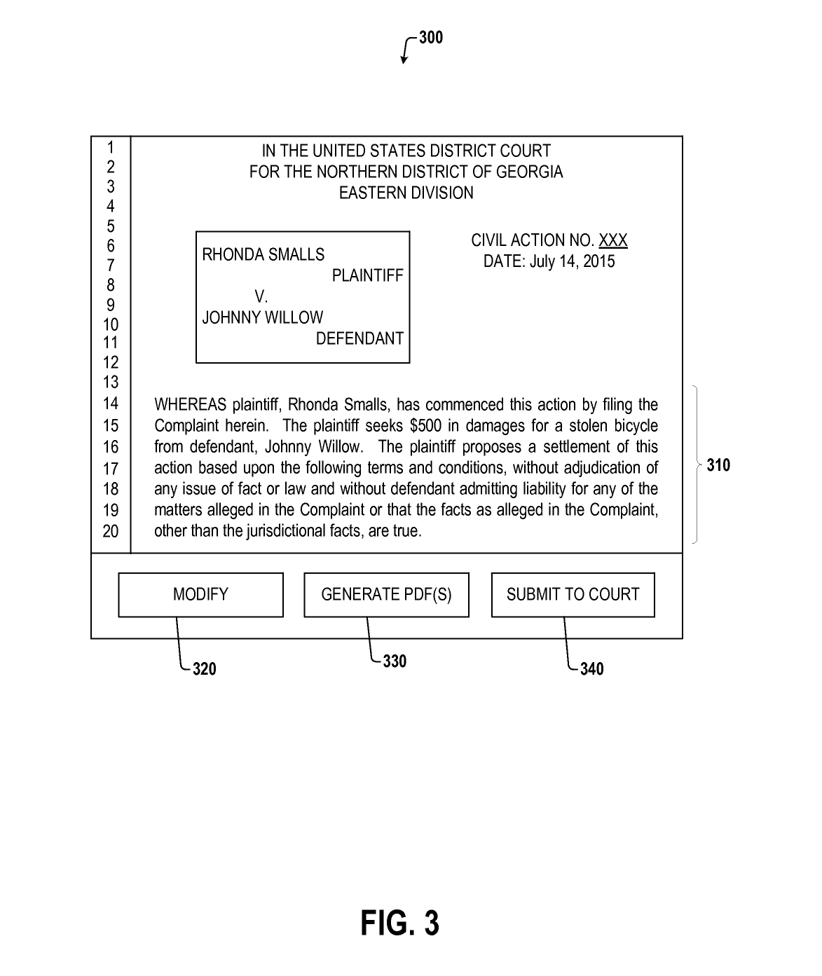

FIG. 3 illustrates an example user interface 300 that enables a user to preview a drafted (e.g., generated) formal complaint document. For example, the system may present to the user the generated formal complaint document(s). As described above, the formal complaint document may include text 310, images, documents, and/or the like that include various pieces of information provided by the user that have been reformatted, reworded, and/or the like so that the text 310 complies with requirements of the selected court(s) 210. For example, user input provided in response to one or more questions 260 via interface 200 may be translated from “plain English” into “legalese” as required or preferred by the selected court(s) 210 in the formal complaint document. The interface 300 may further enable the user to modify 320, using the system, the text 310 and/or other elements of the formal complaint document. For example, the user may desire to add, delete, and/or modify information, causes of action 240, and/or the like. The system may also generate one or more PDFs 330 of the formal complaint documents. In some embodiments, the user may be enabled to download and/or print one or more generated formal complaint documents (e.g., PDFs 330). The system may also submit 340 (e.g., transmit) the generated formal complaint documents directly to the selected court(s) 210 for processing. The system may also generate and/or present to the user instructions for filing such as filing requirements, filing dates, filing fees, court locations (physical and/or electronic), and/or the like.

In some embodiments, the system may transmit the generated formal complaint documents to a third party (e.g., a legal professional such as an attorney, a paralegal, and/or the like) for further review and/or modification. In this manner, if an individual who is a non-legal professional uses the system to generate formal complaint documents, the user may still be enabled to have the formal complaint documents reviewed, modified, and/or submitted by a legal professional without incurring expenses associated with the legal professional drafting the formal complaint documents from scratch. Alternatively, the system may allow a user to consult with an attorney on a reduced price basis in connection with review, modification, and/or submission of the complaint. The system may further enable a user to connect and/or communicate directly with a legal professional. For example, the system may include means for the user to chat, email, message, video chat, teleconference, and/or the like with a legal professional to discuss the formal complaint documents.

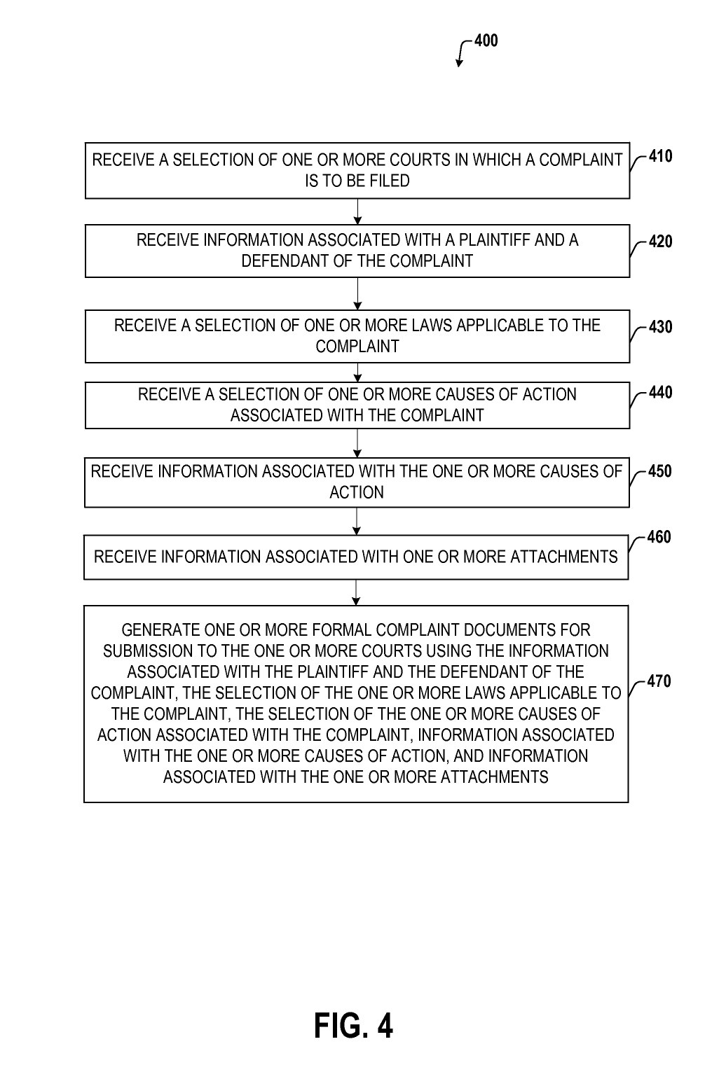

FIG. 4 illustrates an example process flow 400 for utilizing a system that enables the user to quickly and efficiently generate formal complaint documents as described herein. At block 410, the process 400 may include receiving a selection of one or more courts in which a complaint is to be filed. At block 420, the process 400 may include receiving information associated with a plaintiff and a defendant of the complaint. At block 430, the process 400 may include receiving a selection of one or more laws applicable to the complaint. At block 440, the process 400 may include receiving a selection of one or more causes of action associated with the complaint. At block 450, the process 400 may include receiving information associated with the one or more causes of action. At block 460, the process 400 may include receiving information associated with one or more attachments. At block 470, the process 400 may include generating one or more formal complaint documents for submission to the one or more courts using the information associated with the plaintiff and the defendant of the complaint, the selection of the one or more laws applicable to the complaint, the selection of the one or more causes of action associated with the complaint, information associated with the one or more causes of action, and information associated with the one or more attachments.

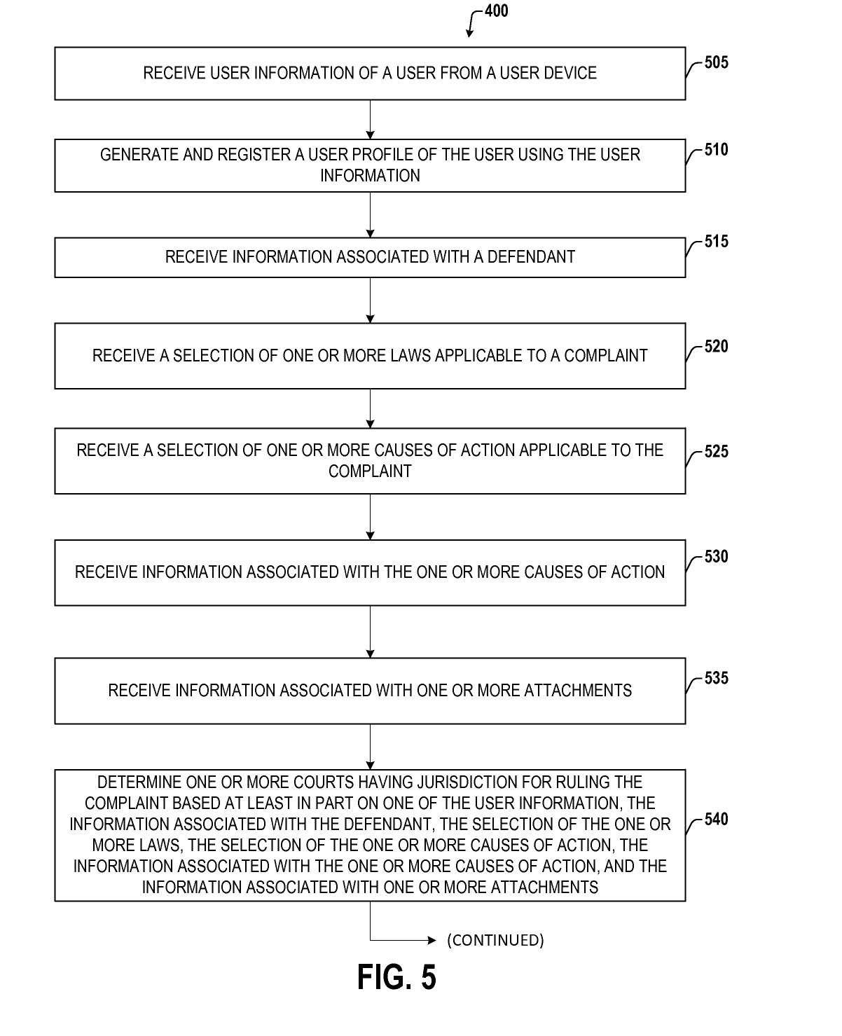

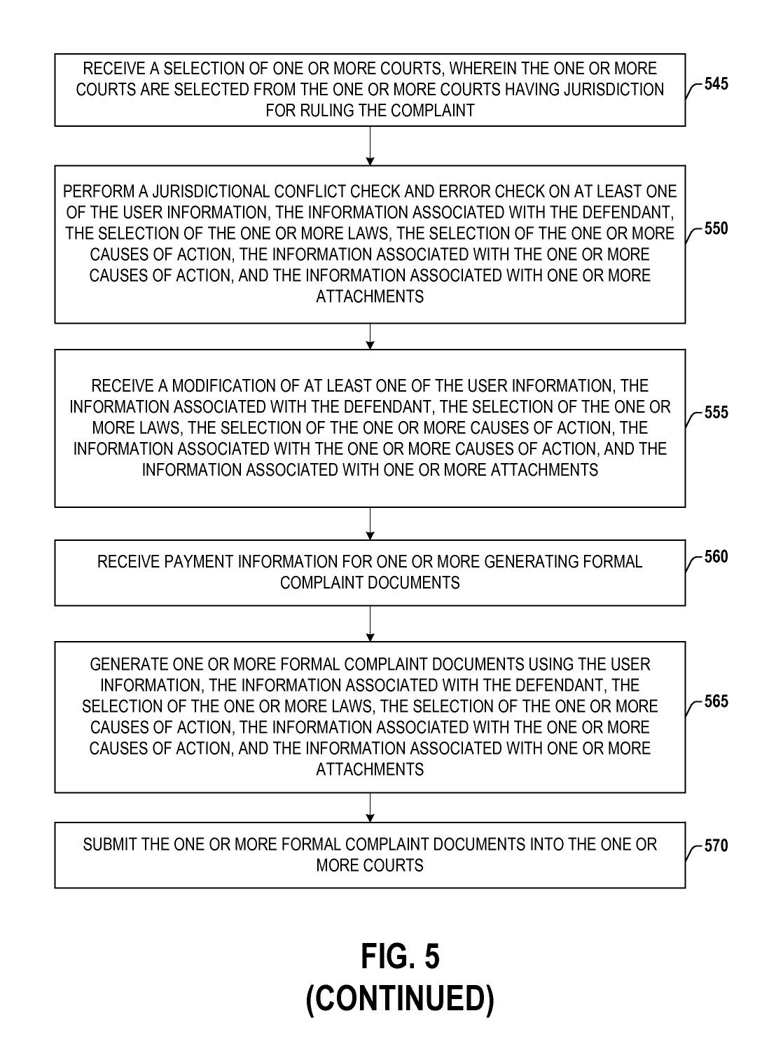

FIG. 5 illustrates an example detailed process flow 500 for utilizing a system that enables the user to quickly and efficiently generate formal complaint documents as described herein. At block 505, the process 500 may include receiving user information of a user from a user device and receiving information for one or more plaintiff(s). At block 510, the process 500 may include generating and register a user profile of the user using the user information. At block 515, the process 500 may include receiving information associated with one or more defendant(s). At block 520, the process 500 may include receiving a selection of one or more laws applicable to a complaint. At block 525, the process 500 may include receiving a selection of one or more causes of action applicable to the complaint. At block 530, the process 500 may include receiving information associated with the one or more causes of action. At block 535, the process 500 may include receiving information associated with one or more attachments. At block 540, the process 500 may include determining one or more courts having jurisdiction for ruling the complaint based at least in part on one of the user information, the information associated with the defendant, the selection of the one or more laws, the selection of the one or more causes of action, the information associated with the one or more causes of action, and the information associated with one or more attachments. At block 545, the process 500 may include receiving a selection of one or more courts, wherein the one or more courts are selected from the one or more courts having jurisdiction for ruling the complaint. At block 550, the process 500 may include performing a jurisdictional conflict check and error check on at least one of the user information, the information associated with the defendant, the selection of the one or more laws, the selection of the one or more causes of action, the information associated with the one or more causes of action, and the information associated with one or more attachments. At block 555, the process 500 may include receiving a modification of at least one of the user information, the information associated with a plaintiff, the information associated with a defendant, the selection of the court for filing, the selection of the one or more laws, the selection of the one or more causes of action, the information associated with the one or more causes of action, and the information associated with one or more attachments. At block 560, the process 500 may include receiving payment information for one or more generating formal complaint documents. At block 565, the process 500 may include generating one or more formal complaint documents using the user and/or plaintiff information, the information associated with a defendant, the selection of the court for filing, the selection of the one or more laws, the selection of the one or more causes of action, the information associated with the one or more causes of action, and the information associated with one or more attachments. At block 570, the process 500 may include submitting the one or more formal complaint documents into the one or more courts.

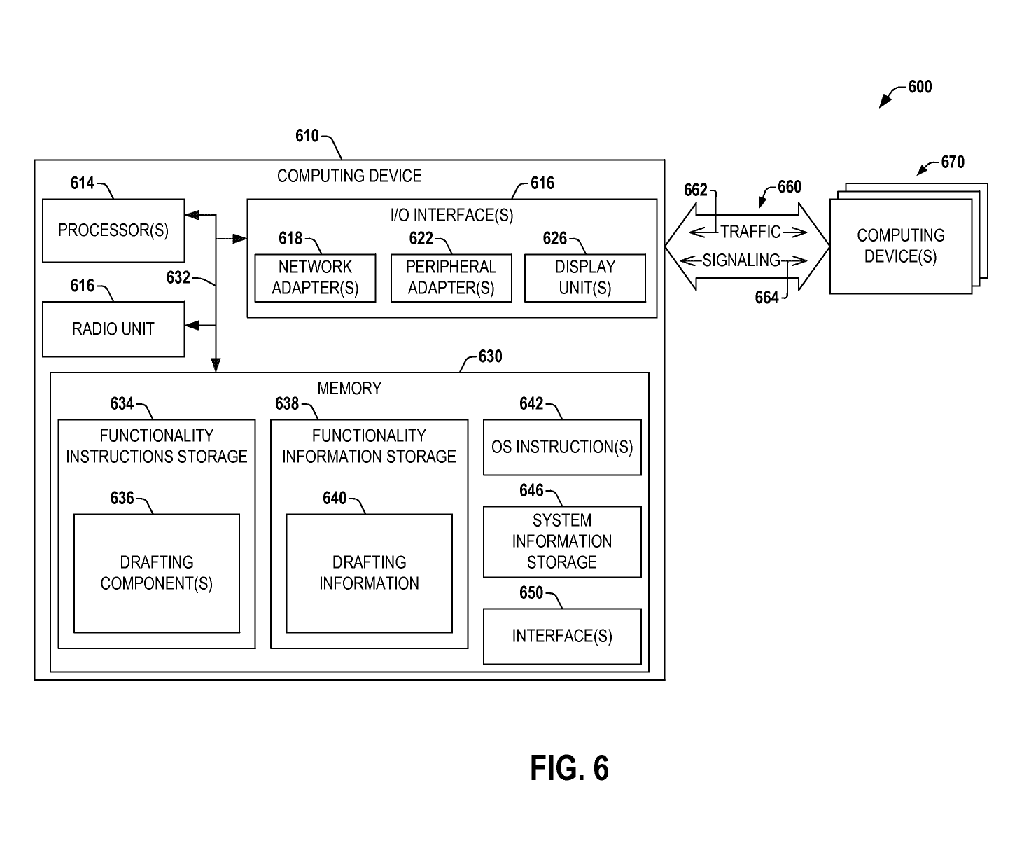

FIG. 6 illustrates an example of a computational environment 600 for executing drafting techniques described herein and/or in accordance with one or more aspects of the disclosure. The example computational environment 600 is only illustrative and is not intended to suggest or otherwise convey any limitation as to the scope of use or functionality of such computational environments' architecture. In addition, the computational environment 600 should not be interpreted as having any dependency or requirement relating to any one or combination of components illustrated in this example computational environment. The illustrative computational environment 600 can embody or can include, for example, a computing device, a laptop computer, a desktop computer, a smart phone, a mobile device, a tablet, a wearable device, and/or any other computing device that can implement or otherwise leverage the drafting techniques and/or functionalities described herein.

The computational environment 600 represents an example of a software implementation of the various aspects or features of the disclosure in which the processing or execution of operations described in connection with drafting techniques described herein, including processing of information communicated (e.g., encoded, modulated, and/or arranged) in accordance with this disclosure, can be performed in response to execution of one or more software components at the computing device 610. It should be appreciated that the one or more software components can render the computing device 610, or any other computing device that contains such components, a particular machine for drafting techniques described herein, including processing of information encoded, modulated, and/or arranged in accordance with aspects described herein, among other functional purposes. A software component can be embodied in or can comprise one or more computer-accessible instructions, e.g., computer-readable and/or computer-executable instructions. At least a portion of the computer-accessible instructions can embody one or more of the example techniques disclosed herein. For instance, to embody one such method, at least the portion of the computer-accessible instructions can be persisted (e.g., stored, made available, or stored and made available) in a computer storage non-transitory medium and executed by a processor. The one or more computer-accessible instructions that embody a software component can be assembled into one or more program modules, for example, that can be compiled, linked, and/or executed at the computing device 610 or other computing devices. Generally, such program modules comprise computer code, routines, programs, objects, components, information structures (e.g., data structures and/or metadata structures), etc., that can perform particular tasks (e.g., one or more operations) in response to execution by one or more processors, which can be integrated into the computing device 610 or functionally coupled thereto.

The various example embodiments of the disclosure can be operational with numerous other general purpose or special purpose computing system environments or configurations. Examples of well-known computing systems, environments, and/or configurations that can be suitable for implementation of various aspects or features of the disclosure in connection with drafting techniques, including processing of information (e.g., user input, and/or the like) in accordance with features described herein, can comprise personal computers; server computers; laptop devices; handheld computing devices, such as mobile tablets; wearable computing devices; and multiprocessor systems. Additional examples can include set top boxes, programmable consumer electronics, network PCs, minicomputers, mainframe computers, blade computers, programmable logic controllers, distributed computing environments that comprise any of the above systems or devices, and the like.

As illustrated, the computing device 610 can comprise one or more processors 614, one or more input/output (I/O) interfaces 616, a memory 630, and a bus architecture 632 (also termed bus 632) that functionally couples various functional elements of the computing device 610. The bus 632 can include at least one of a system bus, a memory bus, an address bus, or a message bus, and can permit exchange of information between the processor(s) 614, the I/O interface(s) 616, and/or the memory 630, or respective functional element therein. In certain scenarios, the bus 632 in conjunction with one or more internal programming interfaces 650 (also referred to as interface(s) 650) can permit such exchange of information. In scenarios in which processor(s) 614 include multiple processors, the computing device 610 can utilize parallel computing.

The I/O interface(s) 616 can permit or otherwise facilitate communication of information between the computing device and an external device, such as another computing device (e.g., a network element, an end-user device, a server, and/or the like). Such communication can include direct communication or indirect communication, such as exchange of information between the computing device 610 and the external device via a network or elements thereof. As illustrated, the I/O interface(s) 616 can comprise one or more of network adapter(s) 618, peripheral adapter(s) 622, and display unit(s) 626. Such adapter(s) can permit or facilitate connectivity between the external device and one or more of the processor(s) 614 or the memory 630. In one aspect, at least one of the network adapter(s) 618 can couple functionally the computing device 610 to one or more computing devices 670 via one or more traffic and signaling pipes 660 that can permit or facilitate exchange of traffic 662 and signaling 664 between the computing device 610 and the one or more computing devices 670. Such network coupling provided at least in part by the at least one of the network adapter(s) 618 can be implemented in a wired environment, a wireless environment, or both. The information that is communicated by the at least one network adapter can result from implementation of one or more operations in a method of the disclosure. Such output can be any form of visual representation, including, but not limited to, textual, graphical, animation, audio, tactile, and the like. In addition or in the alternative, the display unit(s) 626 can include functional elements (e.g., lights, such as light-emitting diodes; a display, such as liquid crystal display (LCD), combinations thereof, or the like) that can permit control of the operation of the computing device 610, or can permit conveying or revealing operational conditions of the computing device 610.

In one aspect, the bus 632 represents one or more of several possible types of bus structures, including a memory bus or memory controller, a peripheral bus, an accelerated graphics port, and a processor or local bus using any of a variety of bus architectures. As an illustration, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus, a PCI-Express bus, a Personal Computer Memory Card Industry Association (PCMCIA) bus, Universal Serial Bus (USB), and the like. The bus 632, and all buses described herein can be implemented over a wired or wireless network connection and each of the subsystems, including the processor(s) 614, the memory 630 and memory elements therein, and the I/O interface(s) 616 can be contained within one or more remote computing devices 670 at physically separate locations, connected through buses of this form, in effect implementing a fully distributed system.

The computing device 610 can comprise a variety of computer-readable media. Computer readable media can be any available media (transitory and non-transitory) that can be accessed by a computing device. In one aspect, computer-readable media can comprise computer non-transitory storage media (or computer-readable non-transitory storage media) and communications media. Example computer-readable non-transitory storage media can be any available media that can be accessed by the computing device 610, and can comprise, for example, both volatile and non-volatile media, and removable and/or non-removable media. In one aspect, the memory 630 can comprise computer-readable media in the form of volatile memory, such as random access memory (RAM), and/or non-volatile memory, such as read only memory (ROM).

The memory 630 can comprise functionality instructions storage 634 and functionality information storage 638. The functionality instructions storage 634 can comprise computer-accessible instructions that, in response to execution (by at least one of the processor(s) 614), can implement one or more of the functionalities of the disclosure. The computer-accessible instructions can embody or can comprise one or more software components illustrated as drafting component(s) 636. In one scenario, execution of at least one component of the drafting component(s) 636 can implement one or more of the techniques disclosed herein. For instance, such execution can cause a processor that executes the at least one component to carry out a disclosed example method. It should be appreciated that, in one aspect, a processor of the processor(s) 614 that executes at least one of the drafting component(s) 636 can retrieve information from or retain information in a memory element 640 in the functionality information storage 638 in order to operate in accordance with the functionality programmed or otherwise configured by the drafting component(s) 636. Such information can include at least one of code instructions, information structures, or the like. At least one of the one or more interfaces 650 (e.g., application programming interface(s)) can permit or facilitate communication of information between two or more components within the functionality instructions storage 634. The information that is communicated by the at least one interface can result from implementation of one or more operations in a method of the disclosure. In certain embodiments, one or more of the functionality instructions storage 634 and the functionality information storage 638 can be embodied in or can comprise removable/non-removable, and/or volatile/non-volatile computer storage media.

At least a portion of at least one of the drafting component(s) 636 or drafting information 640 can program or otherwise configure one or more of the processors 614 to operate at least in accordance with the functionality described herein. One or more of the processor(s) 614 can execute at least one of such components and leverage at least a portion of the information in the storage 638 in order to provide drafting techniques in accordance with one or more aspects described herein. More specifically, yet not exclusively, execution of one or more of the drafting component(s) 636 can permit transmitting and/or receiving information at the computing device 610, as described in connection with FIGS. 1-5, for example.

It should be appreciated that, in certain scenarios, the functionality instruction(s) storage 634 can embody or can comprise a computer-readable non-transitory storage medium having computer-accessible instructions that, in response to execution, cause at least one processor (e.g., one or more of processor(s) 614) to perform a group of operations comprising the operations or blocks described in connection with the disclosed methods.

In addition, the memory 630 can comprise computer-accessible instructions and information (e.g., data and/or metadata) that permit or facilitate operation and/or administration (e.g., upgrades, software installation, any other configuration, or the like) of the computing device 610. Accordingly, as illustrated, the memory 630 can comprise a memory element 642 (labeled OS instruction(s) 642) that contains one or more program modules that embody or include one or more OSs, such as Windows operating system, Unix, Linux, Symbian, Android, Chromium, and substantially any OS suitable for mobile computing devices or tethered computing devices. In one aspect, the operational and/or architecture complexity of the computing device 610 can dictate a suitable OS. The memory 630 also comprises a system information storage 646 having data and/or metadata that permits or facilitate operation and/or administration of the computing device 610. Elements of the OS instruction(s) 642 and the system information storage 646 can be accessible or can be operated on by at least one of the processor(s) 614.

It should be recognized that while the functionality instructions storage 634 and other executable program components, such as the operating system instruction(s) 642, are illustrated herein as discrete blocks, such software components can reside at various times in different memory components of the computing device 610, and can be executed by at least one of the processor(s) 614. In certain scenarios, an implementation of the drafting component(s) 636 can be retained on or transmitted across some form of computer readable media.

The computing device 610 and/or one of the computing device(s) 670 can include a power supply (not shown), which can power up components or functional elements within such devices. The power supply can be a rechargeable power supply, e.g., a rechargeable battery, and it can include one or more transformers to achieve a power level suitable for operation of the computing device 610 and/or one of the computing device(s) 670, and components, functional elements, and related circuitry therein. In certain scenarios, the power supply can be attached to a conventional power grid to recharge and ensure that such devices can be operational. In one aspect, the power supply can include an I/O interface (e.g., one of the network adapter(s) 618) to connect operationally to the conventional power grid. In another aspect, the power supply can include an energy conversion component, such as a solar panel, to provide additional or alternative power resources or autonomy for the computing device 610 and/or one of the computing device(s) 670.

The computing device 610 can operate in a networked environment by utilizing connections to one or more remote computing devices 670. As an illustration, a remote computing device can be a personal computer, a portable computer, a server, a router, a network computer, a peer device or other common network node, and so on. As described herein, connections (physical and/or logical) between the computing device 610 and a computing device of the one or more remote computing devices 670 can be made via one or more traffic and signaling pipes 660, which can comprise wireline link(s) and/or wireless link(s) and several network elements (such as routers or switches, concentrators, servers, and the like) that form a local area network (LAN) and/or a wide area network (WAN). Such networking environments are conventional and commonplace in dwellings, offices, enterprise-wide computer networks, intranets, local area networks, and wide area networks.

In some embodiments, the one or more remote computing devices 670 may include a user device associated with the user. As used herein, the term “user” may be interchangeable with “user device.” For example, the one or more remote computing devices 670 may include a laptop computer, a desktop computer, a smart phone, a tablet, a mobile device, a wearable device, and/or the like. The interfaces 100-300 described herein may be presented to the user via a user device. In some embodiments, the user device may include the same components and/or functionality as the computing device 610.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A method comprising:
identifying, by one or more computer processors coupled to at least one memory, a user profile associated with a plaintiff in a lawsuit;
receiving defendant information comprising a defendant name and a defendant address, wherein the defendant information is associated with a defendant in the lawsuit;
identifying court jurisdictional rules comprising personal jurisdiction information, subject matter jurisdiction information, and venue information;
determining, based at least in part on the user profile, the defendant information, and the court jurisdictional rules, a set of one or more courts in which to file the lawsuit;
presenting the set of one or more courts;
receiving a first selection of a court from the set of one or more courts;
presenting a user interview comprising an open text field for input of information and facts associated with the lawsuit;
receiving the information and facts associated with the lawsuit, wherein the information and facts are in text form;
identifying, based at least in part on the facts, a keyword in the facts indicative of one or more causes of action associated with the lawsuit;
presenting, based at least in part on the keyword, a first option to select an applicable law;
receiving a second selection of a first applicable law;
presenting a second option to select a first cause of action from a set of causes of action identified based at least in part on the selected first applicable law;
receiving a third selection of a cause of action;
determining that the selected first applicable law and the selected first cause of action meet court filing rules of the selected court;
generating a complaint for filing with the selected court by:
processing the facts to identify a first keyword in a first sentence, wherein the first keyword is a plaintiff name;
replacing the first keyword with a first generic term for plaintiff;
processing the facts to identify a second keyword in the first sentence, wherein the second keyword is the defendant name;
replacing the second keyword with a second generic term for defendant;
determining that a third keyword indicates the first sentence is a cause of action;
reformatting the first sentence to comply with the court filing rules of the selected court;
determining that a fourth keyword indicates a second sentence of the facts is a statement of fact;
reformatting the second sentence to comply with the court filing rules of the selected court; and
generating a pdf document for printing and filing with the selected court;
determining a total fee amount due for generating the complaint based at least in part on a number of selected causes of action; and
sending the pdf document to an email address associated with the user profile after receiving an indication of payment of the total fee amount due.

2. The method of claim 1, wherein the pdf document is locked and cannot be electronically edited.

3. The method of claim 1, further comprising parsing the text of the facts to identify the keyword.

4. The method of claim 1, wherein identifying the keyword in the facts comprises using natural language processing.

5. The method of claim 4, wherein identifying the keyword in the facts further comprises comparing individual words of the facts to a set of one or more stored keywords.

6. The method of claim 1, further comprising electronically filing the pdf document with the selected court upon receiving approval to file.

7. The method of claim 1, further comprising:
a jurisdictional conflict check engine com
comparing a first citizenship of each plaintiff to a second citizenship of each defendant; and
determining that the complaint qualifies for diversity jurisdiction based at least in part on the first citizenship and the second citizenship and an amount in controversy requirement, or
determining that the complaint qualifies for Federal subject matter jurisdiction based at least in part on the incorporation of a Federal cause of action constituting a Federal question.

8. A non-transitory computer readable medium including instructions stored thereon, which when executed by one or more processors of a device, cause the device to perform operations of:
identifying a user profile associated with a plaintiff in a lawsuit;
receiving defendant information comprising a defendant name and a defendant address, wherein the defendant information is associated with a defendant in the lawsuit;
identifying court jurisdictional rules comprising personal jurisdiction information, subject matter jurisdiction information, and venue information;
determining, based at least in part on the user profile, the defendant information, and the court jurisdictional rules, a set of one or more courts in which to file the lawsuit;
presenting the set of one or more courts;
receiving a first selection of a court from the set of one or more courts;
presenting an open text field for input of facts associated with the lawsuit;
receiving the facts associated with the lawsuit, wherein the facts are in text form;
identifying, based at least in part on the facts, a keyword in the facts indicative of one or more causes of action associated with the lawsuit;
presenting, based at least in part on the keyword, a first option to select an applicable law;
receiving a second selection of a first applicable law;
presenting a second option to select a first cause of action from a set of causes of action identified based at least in part on the selected first applicable law;
receiving a third selection of a cause of action;
determining that the selected first applicable law and the selected first cause of action meet court filing rules of the selected court;
generating a complaint for filing with the selected court by:
processing the facts to identify a first keyword in a first sentence, wherein the first keyword is a plaintiff name;
replacing the first keyword with a first generic term for plaintiff;
processing the facts to identify a second keyword in the first sentence, wherein the second keyword is the defendant name;
replacing the second keyword with a second generic term for defendant;
determining that a third keyword indicates the first sentence is a cause of action;
reformatting the first sentence to comply with the court filing rules of the selected court;
determining that a fourth keyword indicates a second sentence of the facts is a statement of fact;
reformatting the second sentence to comply with the court filing rules of the selected court; and
generating a pdf document for printing and filing with the selected court;
determining a total fee amount due for generating the complaint based at least in part on a number of selected causes of action; and
sending the pdf document to an email address associated with the user profile after receiving an indication of payment of the total fee amount due.

9. The non-transitory computer readable medium of claim 8, wherein the pdf document is locked and cannot be electronically edited.

10. The non-transitory computer readable medium of claim 8, wherein the instructions, when executed by the one or more processors of the device, further cause the device to perform the operations of:
parsing the text of the facts to identify the keyword.

11. The non-transitory computer readable medium of claim 8, wherein the instructions that cause the device to perform operations of identifying the keyword in the facts comprise instructions that, when executed by the one or more processors of the device, further cause the device to perform the operations of:
identifying the keyword in the facts using natural language processing.

12. The non-transitory computer readable medium of claim 11, wherein the instructions that cause the device to perform operations of identifying the keyword in the facts comprise instructions that, when executed by the one or more processors of the device, further cause the device to perform the operations of:
comparing individual words of the facts to a set of one or more stored keywords.

13. The non-transitory computer readable medium of claim 8, wherein the instructions, when executed by the one or more processors of the device, further cause the device to perform the operations of:
electronically filing the pdf document with the selected court upon receiving approval to file.

14. The non-transitory computer readable medium of claim 8, wherein the instructions, when executed by the one or more processors of the device, further cause the device to perform the operations of:
registering the user profile with at least court of the set of one or more courts.

15. An apparatus comprising:
a transceiver configured to transmit and receive signals;
one or more processors in communication with the transceiver;
at least one memory that stores computer-executable instructions; and
at least one processor of the one or more processors configured to access the at least one memory, wherein the at least one processor of the one or more processors is configured to execute the computer-executable instructions for:
identifying, by one or more computer processors coupled to at least one memory, a user profile associated with a plaintiff in a lawsuit;
receiving defendant information comprising a defendant name and a defendant address, wherein the defendant information is associated with a defendant in the lawsuit;
identifying court jurisdictional rules comprising personal jurisdiction information, subject matter jurisdiction information, and venue information;
determining, based at least in part on the user profile, the defendant information, and the court jurisdictional rules, a set of one or more courts in which to file the lawsuit;
presenting the set of one or more courts;
receiving a first selection of a court from the set of one or more courts;
presenting an open text field for input of facts associated with the lawsuit;
receiving the facts associated with the lawsuit, wherein the facts are in text form;
identifying, based at least in part on the facts, a keyword in the facts indicative of one or more causes of action associated with the lawsuit;
presenting, based at least in part on the keyword, a first option to select an applicable law;
receiving a second selection of a first applicable law;
presenting a second option to select a first cause of action from a set of causes of action identified based at least in part on the selected first applicable law;
receiving a third selection of a cause of action;
determining that the selected first applicable law and the selected first cause of action meet court filing rules of the selected court;
generating a complaint for filing with the selected court by:
processing the facts to identify a first keyword in a first sentence, wherein the first keyword is a plaintiff name;
replacing the first keyword with a first generic term for plaintiff;
processing the facts to identify a second keyword in the first sentence, wherein the second keyword is the defendant name;
replacing the second keyword with a second generic term for defendant;
determining that a third keyword indicates the first sentence is a cause of action;
reformatting the first sentence to comply with the court filing rules of the selected court;
determining that a fourth keyword indicates a second sentence of the facts is a statement of fact;
reformatting the second sentence to comply with the court filing rules of the selected court; and
generating a pdf document for printing and filing with the selected court;
determining a total fee amount due for generating the complaint based at least in part on a number of selected causes of action; and
sending the pdf document to an email address associated with the user profile after receiving an indication of payment of the total fee amount due.

16. The apparatus of claim 15, wherein the pdf document is locked and cannot be electronically edited.

17. The apparatus of claim 15, wherein the at least one processor of the one or more processors is further configured to execute the computer-executable instructions for:
parsing the text of the facts to identify the keyword.

18. The apparatus of claim 15, wherein the computer-executable instructions for identifying the keyword in the facts comprises computer-executable instructions for identifying the keyword in the facts using natural language processing.

19. The apparatus of claim 18, wherein the computer-executable instructions for identifying the keyword in the facts comprises computer-executable instructions for comparing individual words of the facts to a set of one or more stored keywords.

20. The apparatus of claim 15, wherein the at least one processor of the one or more processors is further configured to execute the computer-executable instructions for:
electronically filing the pdf document with the selected court upon receiving approval to file.
